(19) United States
(12) Patent Application Publication
(10) Pub. No.: US 2006/0219645 A1
(43) Pub. Date: Oct. 5, 2006

(54) Self-cleaning strainer

(75) Inventors: Alan J. Bilanin, Princeton, NJ (US); Andrew E. Kaufman, West Windsor, NJ (US)

Correspondence Address: SYNNESTVEDT LECHNER & WOODBRIDGE LLP, P O BOX 592, PRINCETON, NJ, 08542-0592, US

(73) Assignee: Continuum Dynamics, Inc., Ewing, NJ (US)

(21) Appl. No.: 10/556,120

(22) PCT Filed: May 13, 2004
(86) PCT No.: PCT/US04/14875

§ 371 Date: Nov. 8, 2005

Related U.S. Application Data
(60) Provisional application No. 60/470,496, filed on May 15, 2003.

(51) Int. Cl. B01D 29/62

(52) U.S. Cl. 210/791; 210/413

(57) ABSTRACT

An externally powered, self cleaning strainer incorporating a projectile shield, which is capable of operating for an extended period of time. A suitably shaped, motor driven, impeller creates a localized, radially outward flow of fluid in the vicinity of the strainer inlet. The projectile shield has a lower surface shaped to deflect fluid to the strainer at a constant velocity, enabling the impeller to eject debris more efficiently. Maintaining a constant flow through the strainer also avoids additional head loss associated with accelerating flow. The self cleaning strainer may also include a brush attached diametrically opposite to the impeller to aid in removing debris from the inlet side of the strainer. The impeller may also be shaped so that when it is swept past the inlet side of the strainer, it causes a localized, reverse flow through the strainer, thereby removing debris particles from within the strainer.

### CROSS REFERENCE TO RELATED APPLICATIONS

This application is related to, and claims priority from U.S. Provisional Patent application No. 60/470,496 filed on May 15, 2003 by Bilanin, et al. titled “Improved Self Cleaning Strainer”, and to PCT application PCT/US04/14875 filed on May 13, 2004 by Bilanin, et al. titled “Improved Self Cleaning Strainer”, the contents of both of which are hereby incorporated by reference.

### FIELD OF THE INVENTION

The invention relates generally to methods and apparatus for self-cleaning strainers, and more specifically, to improved methods, apparatus, and systems for self-cleaning strainers having reduced pressure drop and incorporating missile debris shielding.

### BACKGROUND OF THE INVENTION

Self-cleaning, self-propelled strainers may be useful components of the emergency core cooling system (ECCS) of Boiling Water Nuclear Reactors (BWR). In the event of a Loss of Coolant Accident (LOCA), the ECCS will need to operate for extended periods of time which may be as long as several months and deal with re-circulating water containing a significant amount of debris. Suitable self-cleaning strainers have been designed for such circumstances as described in, for instance, U.S. Pat. No. 5,688,402, titled “Self-cleaning Strainer”, issued to Green et al on Nov. 18th, 1997, the contents of which are hereby incorporated by reference.

However, such designs are inadequate for Pressurized Water Nuclear Reactors (PWR), which constitute about 70% of operating nuclear reactors in the USA, primarily because of their large head loss (also known as pressure drop) and their lack of a missile shield. These reasons may be better understood by considering differences in the conventional design of BWR and PWR.

In a BWR, the water used to moderate and cool the nuclear core inside the reactor vessel is also the steam source for the turbine. Although this creates the problem that the water is radioactive, it simplifies the overall reactor design and allows the use of a containment structure 10 that includes an inner drywell 12, a weir wall 14 and a suppression pool of water 16 as shown in FIG. 1. The suppression pool 16 serves several functions, including acting as a heat sink and a reservoir of coolant for the emergency core cooling system (ECCS) in the event of a postulated loss-of-coolant accident (LOCA).

Following a LOCA incident, a BWR is shut down but the core 18 must still be cooled down to a temperature at which repairs can be undertaken. Cooling the reactor core may take many weeks, and is done by pumping in emergency coolant from the suppression pool. A postulated LOCA pipe break would cause steam to remove or erode insulation and other materials in the drywell. The steam and subsequent washdown flow carries a significant quantity of fibrous debris material, such as pipe fiberglass thermal insulation, paint chips, corrosion products, and other debris, into the wetwell. This debris must be filtered out before the emergency coolant is pumped back into the reactor core to prevent clogging the reactor vessel. Moreover, the filters removing the debris must themselves remain relatively open for the weeks/months that the ECCS must operate, hence the need for self-cleaning filters of the prior art.

FIG. 2 shows a schematic cross-sectional view of a conventional PWR. In a PWR, the water which passes over the reactor core as a moderator and coolant, does not flow to the turbine, but is contained in a pressurized primary loop 30. The primary loop flows into a heat exchanger that generates steam in a secondary loop. This allows the PWR to operate more efficiently, at a higher pressure and temperature, but complicates the design. As a result, PWR do not have suppression pools, but merely a containment loop 32 that is dry during normal operation and a separate refueling water storage tank 34 (RWST).

In the event of a LOCA incident in a PWR, makeup water is initially pumped in from the RWST 34 to begin cooling the reactor vessel, while the water being lost from the reactor drains to the basement of the containment structure 34. Designs call for operators to close the valves from the RWST and begin recycling the water collecting in the basement as early in the process as feasible, using pumps in the containment sumps 32. However, as in the BWR, in the event of a LOCA in a PWR, the water in the containment structure will contain a significant quantity of debris. The debris is a result of the high-pressure water escaping from a broken pipe scouring thermal insulation, paint and other protective coatings off nearby piping, equipment and structures. The water then carries the debris to the containment sump. As with the BWR, the water may need to be recycled for a time period of the order of months to cool the reactor core sufficiently to allow repairs to be made. During this time, any debris screens will themselves need to be kept clean.

From the foregoing, it can be seen that the screen in a BWR is always submerged by a reasonably significant amount of water, whereas in a PWR, the debris screen is initially uncovered. In the initial stages of a LOCA incident, there is likely to be a significant amount of reasonably large debris or missiles, such as pieces of pipe or structure traveling at significant velocity. The screens in most BWR are protected from these missiles both by the inner drywell and by being covered by water. In most PWR, the screens are exposed to these missiles and may sustain significant damage, unless protected in some way.

A second difference is that the PWR design must operate in relatively shallow water. This requirement means that self-cleaning strainer must eject the debris farther from the strainer than in the BWR case. In a BWR once the material is removed from the strainer it falls down into the relatively deep wet-well. Lacking the water depth of the BWR, the self cleaning strainer in a PWR application must throw the debris farther away, which requires a more efficient impellor. The relatively shallow water for a PWR also requires a very low pressure drop across the screen (also known as head-loss). Too large a pressure drop will result in pump cavitation in the emergency pump, with resultant loss of efficiency and possible damage to the pump and a loss of coolant flow to the reactor. The limited head of water in a PVVR in a postulated LOCA means that the self cleaning screen cannot be self powered by a turbine, as the prior art designs for BWRs are, as the head-loss across the turbine is significant and typically exceeds the acceptable net positive head margin of a PWR emergency core cooling system (ECCS). A typical head loss for a self-cleaning self-powered strainer described in U.S. Pat. No. 5,688,402 is about 3 meters of water, while the acceptable head loss in most PWR is typically less than 1.25 meters.

What is needed is a self-cleaning filter that can be effective in a LOCA incident having a low head loss and incorporating a missile shield.

### SUMMARY OF THE INVENTION

The present invention relates to externally powered, self cleaning strainers having a missile shield and a low pressure drop across the strainer. One object of the invention is to provide an apparatus and method for keeping a strainer free of debris for an extended period of time.

In a preferred embodiment, the self cleaning strainer operates, when submerged in fluid, by creating a localized radially outward flow of the fluid in the vicinity of the inlet side of the strainer. This localized radially outward flow may be created by a suitably shaped impeller (also known as a plough), driven by a motor, being swept round in the vicinity of the inlet side of the strainer and serves to remove debris particles from the inlet side of the strainer. The preferred embodiment also comprises a projectile shield (also known as a missile shield) which protects the strainer from flying debris in the form of projectiles. The projectile shield also has a lower surface shaped so that it improves the performance of the impellor to eject material more efficiently and, the lower surface deflects fluid flowing radially inwards down through the strainer at a constant velocity. An impellor operating in an annular area between the strainer and the projectile shield has improved performance relative to an impellor which has an open area opposite the strainer surface. Maintaining a constant flow through the strainer avoids additional head-loss associated with accelerating flow. The self cleaning strainer may also include a brush attached essentially diametrically opposite to the impeller to aid in removing debris from the inlet side of the strainer. The impeller may also be shaped so that when it is swept round past the inlet side of the strainer, a localized, reverse flow through the strainer, thereby removing debris particles from within the strainer.

These and other features of the invention will be more fully understood by references to the following drawings.

### BRIEF DESCRIPTION OF THE DRAWINGS

FIG. 1 shows a schematic cross-sectional view of a conventional boiling water nuclear reactor (BWR) including the containment structure.

FIG. 2 shows a schematic cross-sectional view of a conventional pressurized water nuclear reactor (PWR) including the containment structure.

FIG. 3 shows various components of an exemplary self-cleaning strainer that can be utilized to implement the inventive concepts described herein.

FIG. 4 shows various components of an alternative exemplary self-cleaning strainer that can be utilized to implement the inventive concepts described herein.

FIG. 5 shows the Net Positive Suction Head (NPSH) margin in feet for the ECCS pumps of a number of US PWRs.

FIG. 6a shows a plan view of the impeller, perforated plate or top mesh and the brush of a preferred embodiment of the invention.

FIG. 6b shows a side elevation of the deflector shield, the impeller, the brush and a drive shaft of a preferred embodiment of the invention.

FIG. 7 shows a schematic cross-section of a preferred embodiment of the invention illustrating velocities and dimensional notation.

FIG. 8 shows a schematic of how the flow field would appear to an observer sitting on the rotating plow.

FIG. 9 shows details of the plow design of a preferred embodiment.

FIG. 10 is a table showing the results of these tests, in which the drag coefficient Cd was determined to be 1.5 for the six inch radius strainer.

FIG. 11 plots the tip speed against the approach velocity for two different plow gaps.

FIG. 12 shows similar results for paint with the brush just touching the perforated plate and the plow at a ¼″ gap.

FIG. 13 is a design curve in which the vertical axis represents strainer plate head loss which is plotted as a function of strainer diameter on the horizontal axis, with the different curves representing flow rate as identified by the right hand box legend.

FIG. 14 is a design curve in which the vertical axis represents the strainer plate approach velocity plotted as a function of strainer diameter on the horizontal axis with the different curves representing different flow rates as identified by the right hand box legend.

FIG. 15 is a design curve in which the vertical axis represents plow/bush rotation which is plotted as a function of strainer diameter on the horizontal axis with the different curves representing different flow rate as identified by the right hand box legend.

FIG. 16 is a design curve in which the vertical axis represents the power required to drive the plow/brush plotted as a function of strainer diameter on the horizontal axis with the different curves representing different flow rates as identified by the right hand box legend.

FIG. 17 is a design curve in which the vertical axis represents estimated turbine head loss of the self-cleaning strainer plotted as a function of required turbine power for the situation in which the strainer is powered by a water turbine.

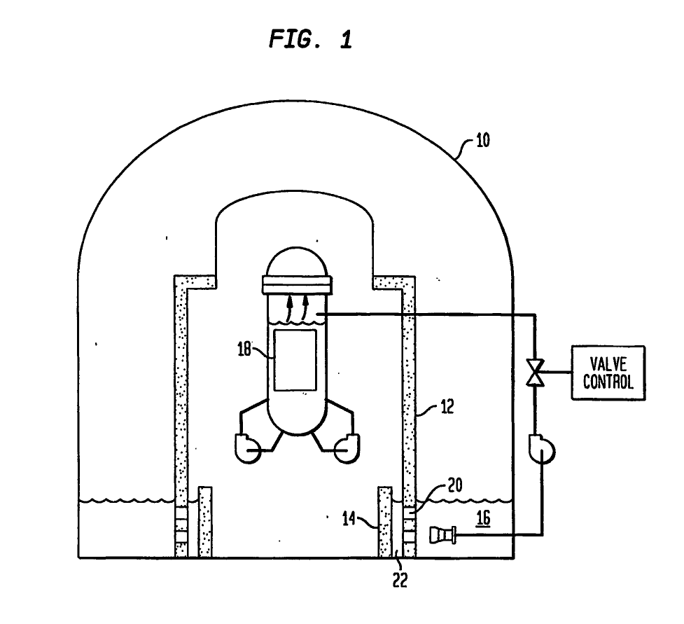

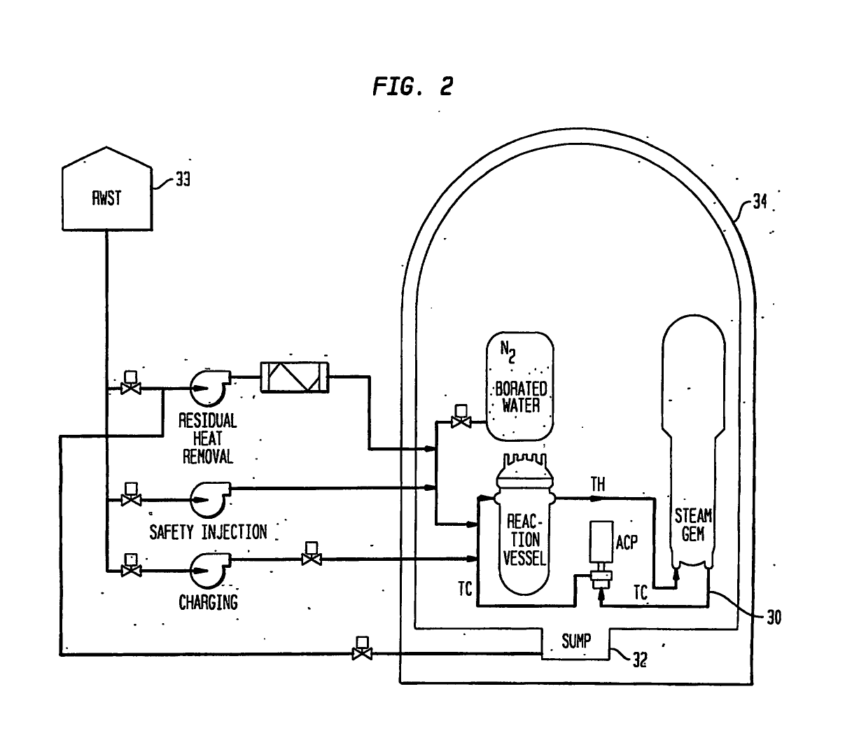

### DETAILED DESCRIPTION

The present invention relates to externally powered, self-cleaning strainers having a missile shield and a low pressure drop across the strainer.

To understand the inventive concepts of the present invention it is useful to refer to the attached drawings in which like numbers refer to like elements.

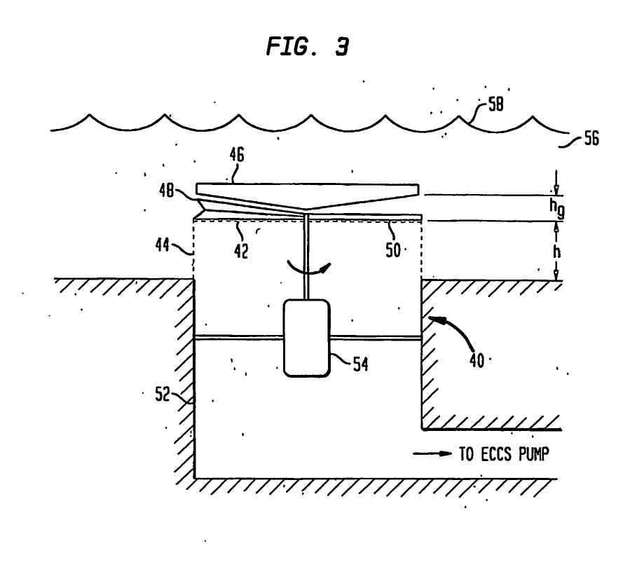

FIG. 3 shows various components of an exemplary self-cleaning strainer that can be utilized to implement the inventive concepts described herein. The self-cleaning strainer includes a top inlet mesh or screen 42, a side inlet mesh or screen 44, a combined jet or missile shield and pump end plate 46, a plow or impeller 48, a brush 50, a loop 52 and a drive motor 54.

The loop 52 and top screen 42 and side screen 44 are typical of dry PWR containments as constructed at many sites within the United States of America. The sump 52 is normally dry, so that at the start of a postulated LOCA, it may be exposed to the initial jet and missile debris predicted in such circumstances. The combined jet/missile shield and pump end plate made of suitable material such as, but not limited to suitable steel, concrete or composite thereof, and of suitable dimensions so as to project the elements of the self-cleaning filter from this initial jet and missile debris.

As the LOCA incident progresses, water or other coolant 56 expelled from the reactor vessel will collect in the containment basement and will then be re-circulated from the sump 52 by the ECCS pumps. This re-circulation will cool the reactor. The water or coolant 56 collecting in the containment basement will also contain a significant amount of debris in the form insulation and protective covering removed from pipes and other structures in the vicinity of the breakage causing the LOCA. This coolant borne debris may include, for instance, shredded fiber glass, reflective metal insulation, particulates, and epoxy paint chips, which need to be removed before the coolant is re-circulated. Although the top and side inlet mesh 42 and 44 will initially filter this debris, the mesh will itself become clogged after some time. In the event of a LOCA, the ECCS is anticipated to be needed for a period that may be as long as several months. It is therefore necessary to have some mechanism for cleaning the screen so that the strainer can continue to operate throughout this period.

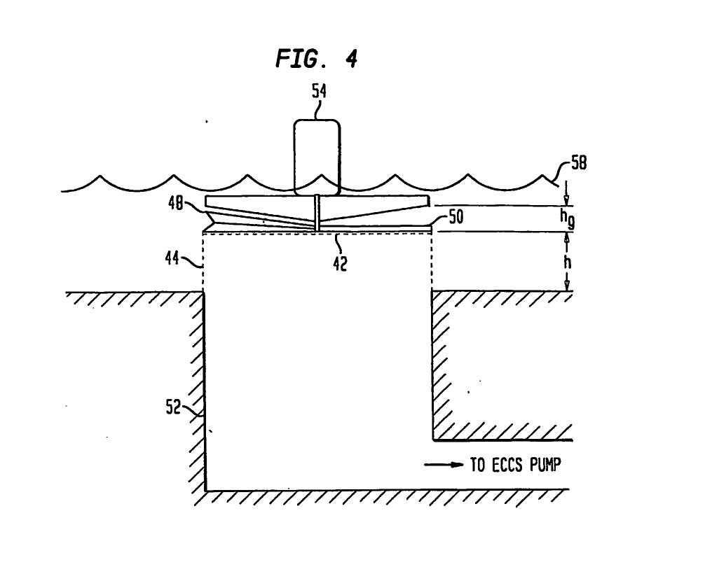

In a preferred embodiment of the invention, this self-cleaning is accomplished by a combination of a brush 50 and a plow/impeller 48, which are driven by the drive motor 54. Drive motor 54 may be, but is not limited to any suitable well-known electric motor, pneumatic motor, hydraulic motor or water powered motor. In the embodiment of FIG. 3, the drive motor is situated directly within the sump and is therefore protected by the missile shield 46. In such a situation, drive motor 54 will need to be capable of operating while submerged for a long period of time. In an alternative embodiment of the invention shown in FIG. 4, the drive motor is situated so as to be above the anticipated accident water level 58 resulting from a LOCA. Such a motor would not need to be capable of operating while submerged, but would need to be protected from the missile/jet debris occurring at the beginning of a LOCA.

Self cleaning of the strainer is accomplished by brush 50 and impeller 48 being swept over the strainer inlet mesh 42. Brush 50 has bristles in close proximity, but not necessarily touching, the perforated strainer mesh 42 which physically dislodges debris. In addition, brush 50 acts as a counterbalance to the rotating impeller 48. As fluid flows radially inward towards the strainer inlet mesh 42, rotating impeller 48 creates a localized, outward flow of fluid. The centrifugal action of this localized outward flow carries debris outward. For debris having a specific gravity greater than the fluid, the debris continues to move radially outward even after the fluid velocity decreases away from the impeller. By this means, the debris is carried out away from the strainer inlet and settles on the containment floor. With proper design of impeller 48, as illustrated later, the water flow in the vicinity of the impeller 48 can be such that there is a localized, reverse flow of the fluid through the strainer which can remove debris particle which from the strainer mesh 42.

The self-cleaning, externally-powered strainer of the preferred embodiment is swept off regularly so that the debris does not have time to accumulate. The head-loss of the strainer is therefore only that of the water passing through the strainer. Importantly, there is no head loss as a result of debris accumulation, meaning that the head loss across the self-cleaning strainer is independent of debris type and quantity.

In addition to acting as a missile shield, the combined missile-shield-and-pump-end assembly 46 has a conical inner surface adjacent to the impeller 48. The conical inner surface is tapered so that the radially inward flow into the strainer remains at a constant speed and avoids head loss associated with accelerating fluid. This shape also improves the efficiency of the impellor.

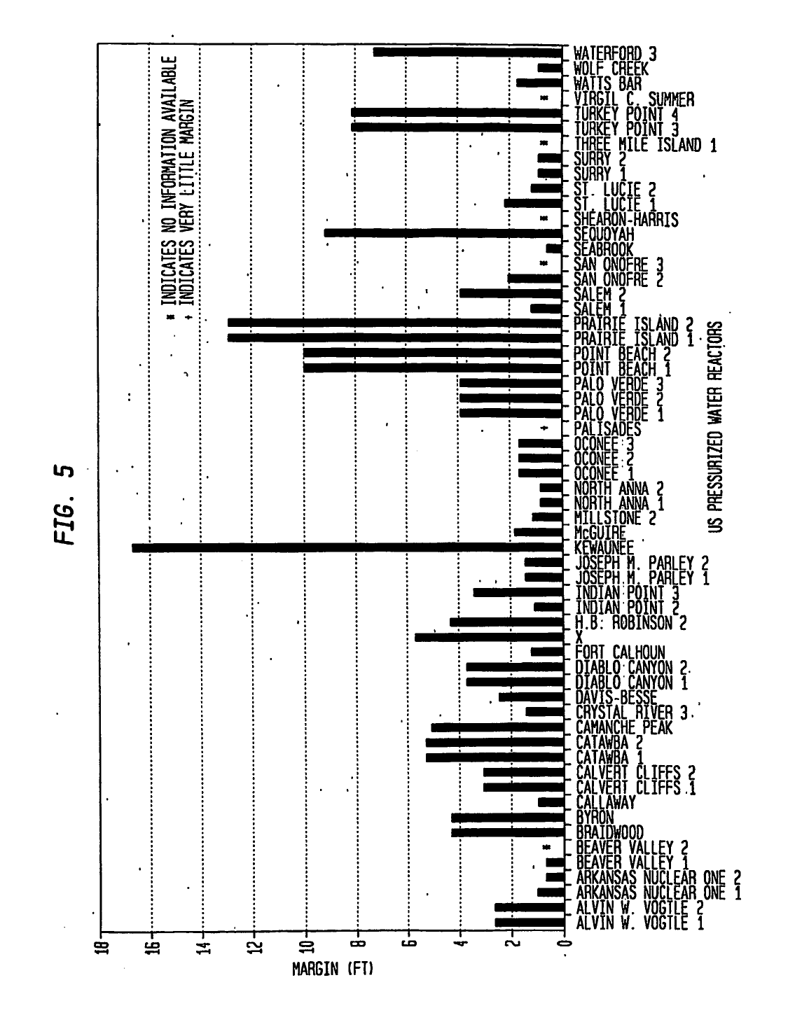

The importance of minimizing head loss across the strainer can be seen from FIG. 5, which shows the Net Positive Suction Head (NPSH) margin in feet for the ECCS pumps of a number of US PWRs. The NPSH Margin is defined as the NPSH Available (NPSHA) at a pump inlet, minus the NPSH required by the pump. Of the fifty-five PWRs in FIG. 5, twenty-six have NPSH margins of less than two feet and thirty-eight have NPSH margins of less than four feet. An effective self-strainer must therefore have a low head loss.

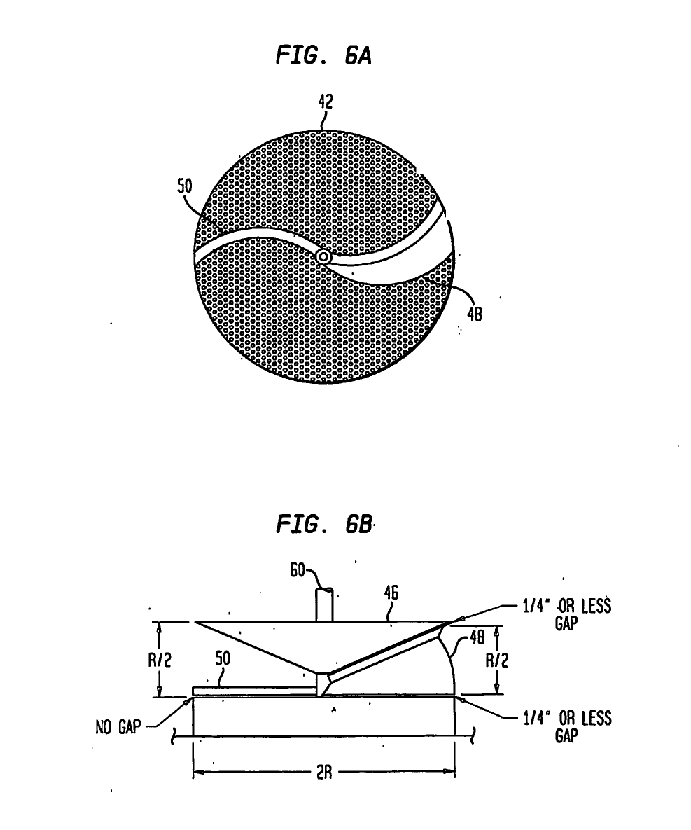

FIG. 6a shows a plan view of the impeller 48, perforated plate or top mesh 42 and the brush 50 of a preferred embodiment of the invention.

FIG. 6b shows a side elevation of the deflector shield 46, the impeller 48, the brush 50 and a drive shaft of a preferred embodiment of the invention. The impeller 48 and brush 50 are driven by a motor attached via the drive shaft 50.

The head loss associated with the preferred embodiment of the invention is nominal and may estimated from the loss of fluid dynamic head through the porous plate, which makes up the strainer surface. The head loss is represented approximately by the equation:

$$h ( ft of {H}_{2 O} ) = \frac{0.015 {( V ( ft \text{/} sec ) )}^{2}}{{( {C}_{V} η )}^{2}}$$

where h represents the head loss in feet of water;

V represents the approach velocity to the strainer ft/sec;

Cv represents the vena contracta of the flow through the strainer plate; and

ηrepresents the open area to total area of the strainer plate.

Assuming a strainer plate that is 40% open and a vena contracta of Cv=0.7, then the head loss as a function of approach velocity may be represented by the following table:

| V (ft/sec) | h (ft) |
|---|---|
| 0.01 | 1.9 × 10⁻⁵ |
| 0.1 | 1.9 × 10⁻³ |
| 1.0 | 1.9 × 10⁻¹ |
| 10.0 | 1.9 × 10 |

Therefore, the head loss is less than 1 ft if the approach velocities are kept less than about 2 ft/sec. Approach velocities to PWR sump screens are typically less than about 2 ft/sec. The improved invention may be incorporated into a PWR ECCS system, and actually improve the safety margin in a plant since the plow and brush essentially eliminate the pressure drop that occurs across passive sump screens as debris is built up on the screen.

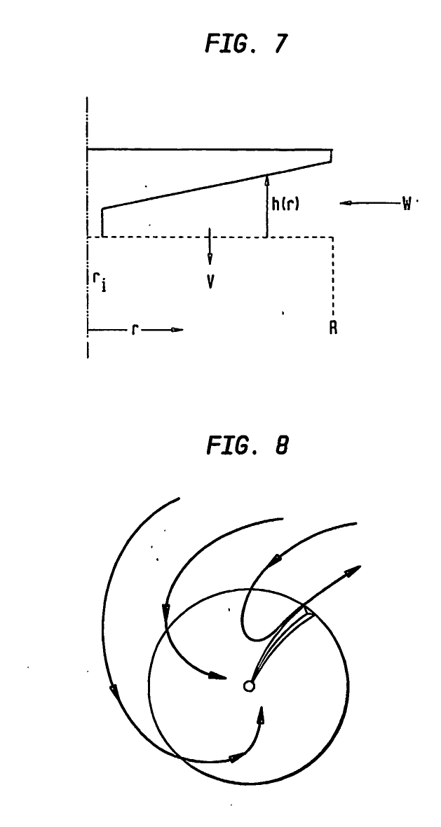

FIG. 7 shows a schematic cross-section of a preferred embodiment of the invention illustrating velocities and dimensional notation, in which:

h (r) represents a distance between the strainer face and the jet/missile deflector plate inner surface, which is a function of radial position;

rᵢ represent a minimum inner radius of strainer plate below which there is no flow into sump (essentially shaft radius);

R represents an outer radius of self-cleaning strainer;

V represents a strainer approach velocity; and

W represents a strainer inlet velocity.

In the preferred embodiment, the centrifugal impeller 48 may rotate at a much higher rate than the velocity, W, which is the velocity of the inlet to the machine.

Assuming that V and W are constant and independent of radius, mass conservation dictates that the jet deflector plate clearance h (r) is represented by the following equation:

$$\frac{h ( r )}{h ( {r}_{i} )} = \frac{{r}_{i}}{r} - \frac{V}{W 2 h ( {r}_{i} )} ( \frac{{r}_{i}^{2}}{r} - r )$$

The design may be simplified by assuming that V is approximately the same as W, or letting V=ηW where η is approximately equal to one. With these approximations, the plate clearance may be represented by the equations:

$$\frac{h ( r )}{h ( {r}_{i} )} = \frac{{r}_{i}}{r} + \frac{η}{2 h ( {r}_{i} )} ( r - \frac{{r}_{i}^{2}}{r} )$$

and rᵢ≦r≦R
Since r/rᵢ is ≧1 the clearance may grow linearly with radius, i.e.,

$$\frac{h ( r )}{{h}_{i}} ∼ \frac{η r}{2 h ( {r}_{i} )}$$

This linearization results in a simplification since a cone can be used which is easily fabricated from sheet material. Now since V is approximately the same as W, the plow may rotate at a rotation rate Ω such that Ω R>>W. Under this condition, the centrifugal action on the debris will jet it radially outward and throw it clear of the strainer so that it is not immediately drawn back to the strainer surface being cleaned. The exact speed will be dependent on the plow design and the specific gravity and shape of the debris. Sitting on the plow the flow field would look like that shown schematically in FIG. 8. Debris that would reach the front of the plow would be ejected radially outward at high velocity. Other debris if attached to the screen is swept off with the brush and then centrifuged by the plow. The head loss of the system is that of a clean strainer provided that the rotation rate of the plow exceeds the deposition rate of the debris.

The rotation time scale may be represented by the equation:
tᵣₒₜ₌2π/Ω

The deposition time is the time the debris takes to cross the radius of the strainer may be represented by the equation:

$${t}_{dep} ∼ \frac{R}{W}$$

A requirement to keep the strainer surface clean may be represented by the equation:

$$\frac{{t}_{rot}}{{t}_{dep}} ⪡ 1$$

so that RΩ>>2πW

The tip speed of the plow RΩ is preferably greater than 2π times the strainer inlet velocity. The preferred functional form of the gap between the strainer face and the jet/missile deflector plate inner surface, h, is given above, but the radial variation may be linearized or made constant. The plow and brush may be applied to any of the sump strainer surfaces and multiple plows and brushes may be used to increase performance or safety.

A preferred embodiment of the design was tested using a self-cleaning strainer that is one foot in diameter. These tests measured the torque required to drive the plow and brush and determined design values for the drag coefficient Cd.

The tests also determined the clearances for the plow and the brush from the strainer surface plate and end plate that are large, but still permit removal of accumulated debris from the strainer. The tests also used full-scale velocities with prototypical debris to more accurately simulate the pressure drop across the debris which holds the debris to the strainer perforated plate.

In testing a preferred embodiment, the flow rate in the Low Speed Water Tunnel was approximately 600 gpm and the strainer had a radius of six inches. The maximum approach velocity was 1.6 ft/sec and the skirt height (also known as the side inlet mesh) was three inches, or half the radius of the strainer. The strainer deflector shield was mounted on drill rod rails so that the deflector shield could be moved to adjust the gap between the strainer surface and the plow and the deflector shield and the plow. During testing the skirt was covered with sheet metal so that the total flow was through the surface of the strainer plate thereby maximizing the pressure drop across the plate which is the limiting test for debris removal for the plow and brush assembly.

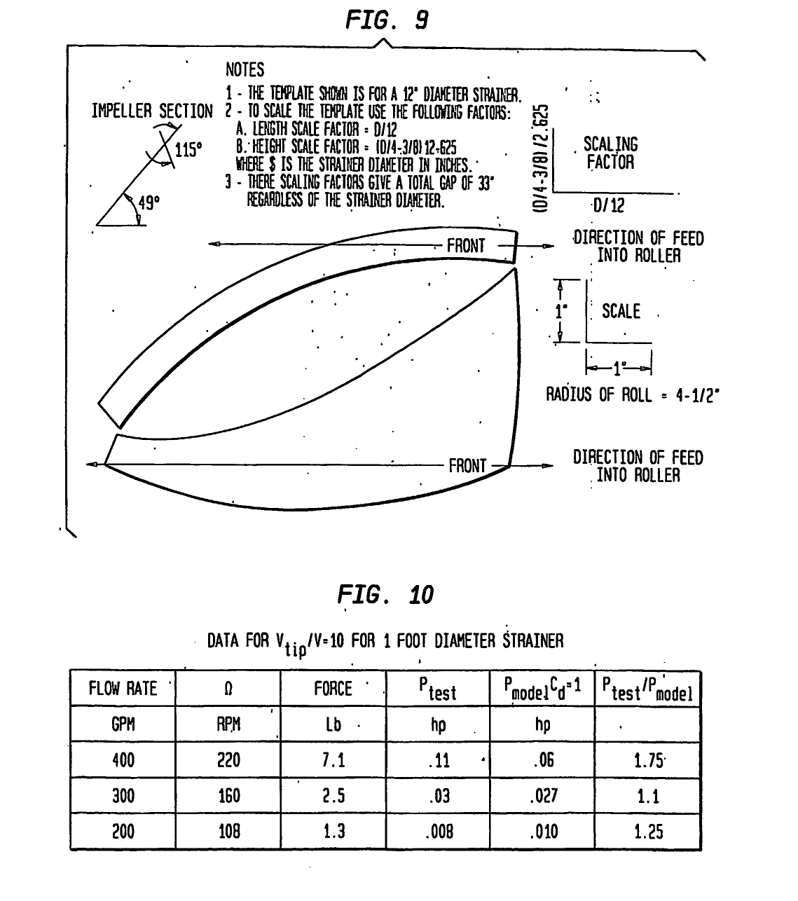

The details of the plow design of a preferred embodiment are shown in FIG. 9. This drawing may be scaled for R different than 6″.

FIG. 10 is a table showing the results of these tests, in which the drag coefficient Cd was determined to be 1.5 for the six inch radius strainer.

The ability of the self-cleaning strainer to remove debris was judged qualitatively by observing whether debris stuck to the strainer. Two types of debris were independently tested, fiberglass and paint chips. Fiberglass insulation was prepared by shredding the insulation into small pieces to simulate debris from a LOCA following size distributions provided in NUREG 6224. The insulation was shredded by hand and then wet before placing it in the test section. Ameron epoxy paint chips, approximately 5-10 mils thick and ¼″×¼″ to 1″×1″, were used.

For the debris tests, the approach velocity and strainer rpm were set and the insulation was added. The strainer rpm was slowly increased to determine when debris no longer adhered to the strainer. More debris was added if debris sunk to the bottom of the test facility and was no longer sucked toward the strainer.

FIG. 11 plots the tip speed against the approach velocity for two different plow gaps. The lines indicate the minimum rotation rate required to remove the fiberglass from the strainer. With a ⅛″ gap, Vtip/V ratios of 5-7 are sufficient to remove the fiber. With a ¼″ gap, Vtip/V ratios of 7-10 are sufficient to remove the fiber.

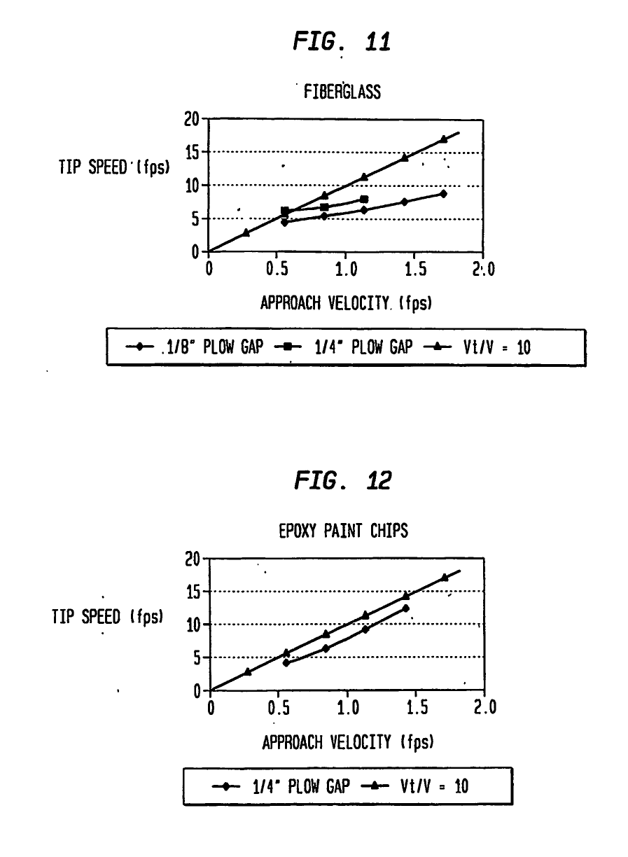

FIG. 12 shows similar results for paint with the brush just touching the perforated plate and the plow at a ¼″ gap. The paint chips required a Vtip/V ratio of 10 to remove the paint chips from the strainer surface.

Other Considerations

Anti Vortexing.

The fact that the plow continuously exerts a torque on the fluid as it enters the ECCS suction lines can generate a vortex. This is eliminated by incorporating flow straightening plates into the strainer that is motor driven. In the case of a water turbine driven machine, the turbine itself could be designed to straighten the flow leaving the strainer surface plate. The sizing of the required flow straightening plates is estimated by noting that the torque applied to the fluid by the plow and brush must result in an axial flux of angular momentum leaving the self-cleaning strainer.

Cavitation About the Plow.

Since the plow is moving rapidly i.e., about 10 times the approach velocity, the possibility that the pressure drop in the water in the vicinity of the plow results in boiling. To avoid cavitation requires that the tip speed be less than that given by the equation
VT=ΩR<\sqrt{2gH}
in which H represents the submergence of the plough. From this it follows that if approach velocities to the strainer are limited to about 1.25 ft/sec, tip speeds are then 12.5 ft/sec. In such conditions, the plow requires about 2 feet of water above it to avoid cavitation. This requirement is met in most containments.
Dynamic Balance

The combined plow and brush assembly should be statically balanced to minimize rotational vibration.

Design Curve

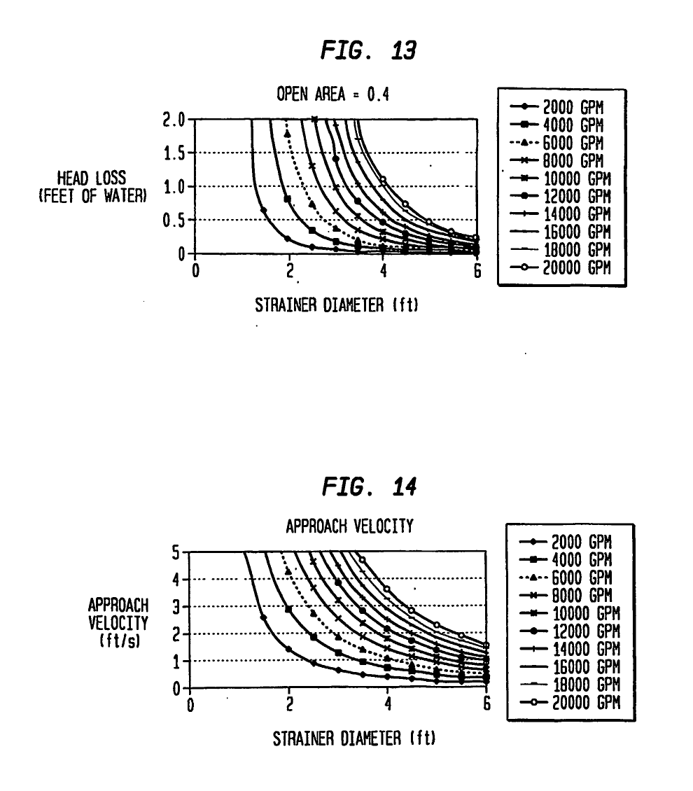

FIG. 13 is a design curve in which the vertical axis represents strainer plate head loss which is plotted as a function of strainer diameter on the horizontal axis, with the different curves representing flow rate as identified by the right hand box legend. These curves are valid for perforated plate having an open area of 40%.

FIG. 14 is a design curve in which the vertical axis represents the strainer plate approach velocity plotted as a function of strainer diameter on the horizontal axis with the different curves representing different flow rates as identified by the right hand box legend.

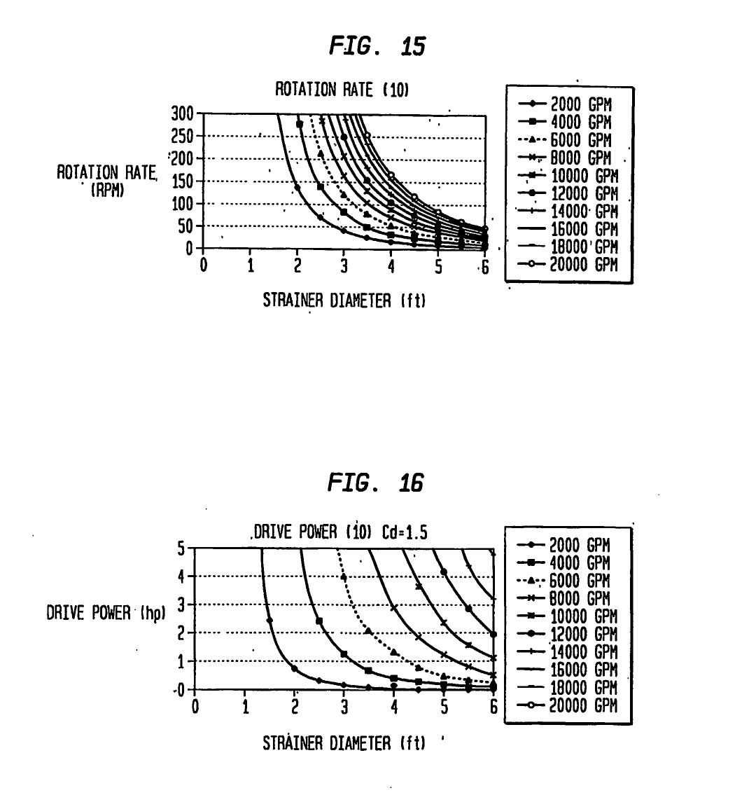

FIG. 15 is a design curve in which the vertical axis represents plow/bush rotation which is plotted as a function of strainer diameter on the horizontal axis with the different curves representing different flow rate as identified by the right hand box legend. The plough tip velocity to approach velocity ratio in these design curves is assumed to be 10 (VT/V=10).

FIG. 16 is a design curve in which the vertical axis represents the power required to drive the plow/brush which is plotted as a function of strainer diameter on the horizontal axis with the different curves representing different flow rates as identified by the right hand box legend.

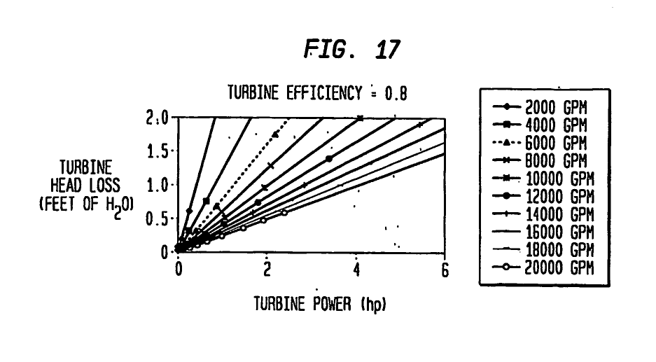

FIG. 17 is a design curve in which the vertical axis represents estimated turbine head loss of the self-cleaning strainer which is plotted as a function of required turbine power for the situation in which the strainer is powered by a water turbine. (The turbine efficiency is assumed to be 80%).

In the field of nuclear reactor design there is significant interest in self-cleaning strainers and particularly externally powered, self cleaning strainers having a missile shield and a low pressure drop across the strainer. Such self-cleaning strainers would be of considerable utility as, for instance, the self-cleaning strainers in the inlet to emergency coolant circulation systems (ECCS) in pressurized water reactors (PWR)s in the event of a loss of coolant accident (LOCA).

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A strainer self-cleaning method, comprising:
protecting an inlet side of said strainer from projectile debris;
creating a radially inward flow of a fluid in the vicinity of said inlet side of said strainer;
deflecting said radially inward flow of said fluid to flow through said strainer;
generating a localized, radially outward-flow of said fluid in the vicinity of said inlet side said strainer; and,
sweeping said localized, radially outward flow of a fluid over substantially all of said inlet side of said strainer, thereby removing one or more debris particles from said inlet side of said strainer.

2. The method as recited in claim 1, wherein said protecting said inlet side of said strainer includes providing a projectile shield and wherein said deflecting said radially inward flow utilizes a lower surface of said projectile shield and wherein said deflecting said radially inward flow creates a substantially constant speed flow through said strainer, thereby avoiding additional head loss associated with accelerating flow.

3. The method as recited in claim 2 wherein said lower surface of said projectile shield is formed according to the equation
$$\frac{h ( r )}{h ( {r}_{i} )} = \frac{{r}_{i}}{r} - \frac{V}{W 2 h ( {r}_{i} )} ( \frac{{r}_{i}^{2}}{r} - r )$$
in which h (r) represents the distance between said inlet side of said strainer and an inner surface of said lower surface of said projectile shield, which is a function of radial position; rᵢ represents a minimum inner radius of said strainer below which there is no fluid flow; R represents an outer radius of said strainer; W represents an approach velocity of said fluid; and V represents said constant flow through said strainer inlet velocity.

4. The method as recited in claim 2 wherein said lower surface of said projectile shield is formed according to the equation
$$\frac{h ( r )}{{h}_{i}} ∼ \frac{η r}{2 h ( {r}_{i} )}$$
in which h (r) represents the distance between said inlet side of said strainer and said lower surface of said projectile shield, which is a function of radial position.

5. The method as recited in claim 1 further including generating a localized, reverse flow of said fluid through said strainer and sweeping said localized, reverse flow over substantially all of said strainer, thereby removing one or more debris particles from said strainer.

6. The method as recited in claim 1 wherein said generating a localized, radially outward flow of a fluid and said sweeping said localized, radially outward flow of a fluid over substantially all of said inlet side of said strainer are both accomplished by a suitably shaped, rotating plough.

7. The method as recited in claim 1 further including brushing said inlet side of said strainer.

8. A self-cleaning strainer apparatus, comprising:
a projectile shield situated so as to protect an inlet side of said strainer from projectile debris;
an impeller situated between said projectile shield and said inlet side of said strainer; and
a drive motor attached to said impeller and capable of sweeping said impeller over substantially all of said inlet side of said strainer.

9. The apparatus as recited in claim 8, wherein a lower surface of said projectile shield is shaped to deflect a radially inward flow of a fluid through said strainer at a substantially constant velocity; an upper edge of said impeller is shaped to have a substantially constant clearance gap from said lower surface of said projectile shield; a lower edge of said impeller is shaped to have a substantially constant clearance gap from said inlet side of said strainer; and said impeller is shaped such that sweeping said impeller over substantially all of said inlet side of said strainer is capable of generating a localized, radially outward flow of said fluid, thereby removing one or more debris particles from said inlet side of said strainer.

10. The apparatus as recited in claim 9 wherein said lower surface of said projectile shield is formed according to the equation
$$\frac{h ( r )}{h ( {r}_{i} )} = \frac{{r}_{i}}{r} - \frac{V}{W 2 h ( {r}_{i} )} ( \frac{{r}_{i}^{2}}{r} - r )$$
in which h (r) represents the distance between said inlet side of said strainer and an inner surface of said lower surface of said projectile shield, which is a function of radial position; rᵢ represents a minimum inner radius of said strainer below which there is no fluid flow; R represents an outer radius of said strainer; W represents an approach velocity of said fluid; and V represents said constant flow through said strainer inlet velocity.

11. The apparatus as recited in claim 9 wherein said lower surface of said projectile shield is formed according to the equation
$$\frac{h ( r )}{{h}_{i}} ∼ \frac{η r}{2 h ( {r}_{i} )}$$
in which h (r) represents the distance between said inlet side of said strainer and said lower surface of said projectile shield, which is a function of radial position.

12. The apparatus as recited in claim 9 wherein said impeller is shaped such that sweeping said impeller over substantially all of said inlet side of said strainer is further capable of generating a localized, reverse flow of said fluid through said strainer, thereby removing one or more debris particles from said strainer.

13. The apparatus as recited in claim 9 wherein said substantially constant clearance gap between said upper edge of said impeller and said lower surface of said projectile shield is in the range of zero to ¼ of an inch, and wherein said substantially constant clearance gap between said lower edge of said impeller and said inlet side of said strainer is in the range of zero to 1/4 of an inch, and wherein said impeller is swept such that a ratio of the velocity of the impeller tip to said substantially constant velocity of said fluid through said strainer is in the range of 5 to 15.

14. The apparatus as recited in claim 1 further including a brush attached radially opposite to said impeller.

15. A self-cleaning strainer device, comprising:
a projectile shield means situated so as to protect an inlet side of said strainer from projectile debris;
an impeller means situated between said projectile shield and said inlet side of said strainer; and
a drive motor means capable of sweeping said impeller over substantially all of said inlet side of said strainer.

16. The device as recited in claim 15, wherein a lower surface of said projectile shield means is shaped to deflect a radially inward flow of a fluid through said strainer at a substantially constant velocity; said impeller means is shaped such that sweeping said impeller over substantially all of said inlet side of said strainer is capable of generating a localized, radially outward flow of said fluid, thereby removing one or more debris particles from said inlet side of said strainer.

17. The device as recited in claim 16 wherein said lower surface of said projectile shield means is formed according to the equation
$$\frac{h ( r )}{h ( {r}_{i} )} = \frac{{r}_{i}}{r} - \frac{V}{W 2 h ( {r}_{i} )} ( \frac{{r}_{i}^{2}}{r} - r )$$
in which h (r) represents the distance between said inlet side of said strainer and an inner surface of said lower surface of said projectile shield, which is a function of radial position; rᵢ represents a minimum inner radius of said strainer below which there is no fluid flow; R represents an outer radius of said strainer; W represents an approach velocity of said fluid; and V represents said constant flow through said strainer inlet velocity.

18. The device as recited in claim 16 wherein said lower surface of said projectile shield means is formed according to the equation
$$\frac{h ( r )}{{h}_{i}} ∼ \frac{η r}{2 h ( {r}_{i} )}$$
in which h (r) represents the distance between said inlet side of said strainer and said lower surface of said projectile shield means, which is a function of radial position.

19. The device as recited in claim 16 wherein said impeller means is shaped such that sweeping said impeller over substantially all of said inlet side of said strainer is further capable of generating a localized, reverse flow of said fluid through said strainer, thereby removing one or more debris particles from said strainer.

20. The device as recited in claim 16 wherein a substantially constant clearance gap between said upper edge of said impeller means and said lower surface of said projectile shield means is in the range of zero to ¼ of an inch; a substantially constant clearance gap between said lower edge of said impeller means and said inlet side of said strainer is in the range of zero to ¼ of an inch; and said impeller means is swept such that a ratio of the velocity of the impeller tip to said substantially constant velocity of said fluid through said strainer is in the range of 5 to 15.

21. The device as recited in claim 16 further including a brush means capable of brushing one or more debris particles from said inlet side of said strainer, said brush means being attached radially opposite to said impeller means.
